(19) United States
(12) Patent Application Publication
(10) Pub. No.: US 2018/0242289 A1
(43) Pub. Date: Aug. 23, 2018

(54) Transmission and Reception of Grant for Resources

(71) Applicant: Telefonaktiebolaget LM Ericsson (publ), Stockholm (SE)

(72) Inventors: Niklas Andgart, Lund (SE); Laetitia Falconetti, Järfälla (SE)

(21) Appl. No.: 15/756,117

(22) PCT Filed: Jan. 24, 2018
(86) PCT No.: PCT/EP2018/051648

§ 371 Date: Feb. 28, 2018

Related U.S. Application Data
(60) Provisional application No. 62/455,050, filed on Feb. 6, 2017.

(51) Int. Cl. H04W 72/04; H04W 72/14; H04W 72/12; H04L 5/00

(52) U.S. Cl. CPC H04W 72/042; H04W 72/14; H04L 5/0053; H04W 72/1263; H04W 72/0446

(57) ABSTRACT

A method for transmitting grant for resources to a wireless device is disclosed. The method is performed by a network node and comprises transmitting the grant for resources to the wireless device. A corresponding method for receiving granting of resources from a network node is also disclosed. The method is performed by a wireless device and comprises receiving the grant for resources from the network node. The grant comprises a first indicator indicating data resources allocated to the wireless device in a downlink data channel. The grant comprises a second indicator indicating whether control signaling resources configured for the wireless device are used for data transmission to the wireless device or are not used for data transmission to the wireless device.

### BACKGROUND

Embodiments presented herein relate to a method, a network node, a computer program, and a computer program product for transmitting grant for resources to a wireless device. Embodiments presented herein further relate to a method, a wireless device, a computer program, and a computer program product for receiving granting of resources from a network node.

In communications networks, there may be a challenge to obtain good performance and capacity for a given communications protocol, its parameters and the physical environment in which the communications network is deployed.

For example, one parameter in providing good performance and capacity for a given communications protocol in a communications network is packet data latency. Latency measurements can be performed in all stages of the communications network, for example when verifying a new software release or system component, and/or when deploying the communications network and when the communications network is in commercial operation.

Shorter latency than previous generations of 3GPP radio access technologies was one performance metric that guided the design of Long Term Evolution (LTE). LTE is also now recognized by the end-users to be a system that provides faster access to internet and lower packet latencies than previous generations of mobile radio technologies.

Packet latency is also a parameter that indirectly influences the throughput of the communications network. Traffic using the Hypertext Transfer Protocol (HTTP) and/or the Transmission Control Protocol (TCP) is currently one of the dominating application and transport layer protocol suite used on the Internet. The typical size of HTTP based transactions over the Internet is in the range of a few 10's of Kilo byte up to 1 Mega byte. In this size range, the TCP slow start period is a significant part of the total transport period of the packet stream. During TCP slow start the performance is packet latency limited. Hence, improved packet latency can potentially improve the average throughput, at least for this type of TCP based data transactions.

Radio resource efficiency could also be positively impacted by packet latency reductions. Lower packet data latency could increase the number of transmissions possible within a certain delay bound; hence higher Block Error Rate (IDLER) targets could be used for the data transmissions freeing up radio resources potentially improving the capacity of the system.

The existing physical layer downlink control channels, Physical Downlink Control Channel (PDCCH) and enhanced PDCCH (ePDCCH), are used to carry Downlink Control Information (DCI) such as scheduling decisions for uplink (UL; from device to network) and downlink (DL; from network to device) and power control commands. Both PDCCH and ePDCCH are according to present communications networks transmitted once per 1 ms subframe.

The existing way of operation, e.g. frame structure and control signaling, are designed for data allocations in subframe of a fixed length of 1 ms, which may vary only in allocated bandwidth. Specifically, the current DCIS define resource allocations within the entire subframe, and are only transmitted once per subframe.

Further, the existing way of operation, including time-division multiplex as used by PDCCH, and frequency-division multiplex, as used by ePDCCH are designed for fixed amounts of control signaling and data allocation. This could lead to an inefficient utilization of the resources.

Hence, there is still a need for efficient utilization of resources allocated to a wireless device.

### SUMMARY

An object of embodiments herein is to provide mechanisms enabling efficient utilization of resources allocated to a wireless device. According to a first aspect there is presented a method for transmitting grant for resources to a wireless device. The method is performed by a network node. The method comprises transmitting the grant for resources to the wireless device. The grant comprises a first indicator indicating data resources allocated to the wireless device in a downlink data channel. The grant comprises a second indicator indicating whether control signaling resources configured for the wireless device are used for data transmission to the wireless device or are not used for data transmission to the wireless device.

According to a second aspect there is presented a network node for transmitting grant for resources to a wireless device. The network node comprises processing circuitry. The processing circuitry is configured to cause the network node to transmit the grant for resources to the wireless device. The grant comprises a first indicator indicating data resources allocated to the wireless device in a downlink data channel. The grant comprises a second indicator indicating whether control signaling resources configured for the wireless device are used for data transmission to the wireless device or are not used for data transmission to the wireless device.

According to a third aspect there is presented a network node for transmitting grant for resources to a wireless device. The network node comprises processing circuitry and a storage median. The storage medium stores instructions that, when executed by the processing circuitry, cause the network node to transmit the grant for resources to the wireless device. The grant comprises a first indicator indicating data resources allocated to the wireless device in a downlink data channel. The grant comprises a second indicator indicating whether control signaling resources configured for the wireless device are used for data transmission to the wireless device or are not used for data transmission to the wireless device.

According to a fourth aspect there is presented a network node for transmitting grant for resources to a wireless device. The network node comprises a transmit module configured to transmit the grant for resources to the wireless device. The grant comprises a first indicator indicating data resources allocated to the wireless device in a downlink data channel. The grant comprises a second indicator indicating whether control signaling resources configured for the wireless device are used for data transmission to the wireless device or are not used for data transmission to the wireless device.

According to a fifth aspect there is presented a computer program for transmitting grant for resources to a wireless device, the computer program comprises computer program code which, when run on processing circuitry of a network node, causes the network node to perform a method according to the first aspect.

According to a sixth aspect there is a method for receiving granting of resources from a network node. The method is performed by a wireless device. The method comprises receiving the grant for resources from the network node. The grant comprises a first indicator indicating data resources allocated to the wireless device in a downlink data channel. The grant comprises a second indicator indicating whether control signaling resources configured for the wireless device are used for data transmission to the wireless device or are not used for data transmission to the wireless device.

According to a seventh aspect there is presented a wireless device for receiving granting of resources from a network node. The wireless device comprises processing circuitry. The processing circuitry is configured to cause the wireless device to receive the grant for resources from the network node. The grant comprises a first indicator indicating data resources allocated to the wireless device in a downlink data channel. The grant comprises a second indicator indicating whether control signaling resources configured for the wireless device are used for data transmission to the wireless device or are not used for data transmission to the wireless device.

According to an eighth aspect there is presented a wireless device for receiving granting of resources from a network node. The wireless device comprises processing circuitry and a storage medium. The storage medium stores instructions that, when executed by the processing circuitry, cause the wireless device to receive the grant for resources from the network node. The grant comprises a first indicator indicating data resources allocated to the wireless device in a downlink data channel. The grant comprises a second indicator indicating whether control signaling resources configured for the wireless device are used for data transmission to the wireless device or are not used for data transmission to the wireless device.

According to a ninth aspect there is presented a wireless device for receiving granting of resources from a network node. The wireless device comprises a receive module configured to receive the grant for resources from the network node. The grant comprises a first indicator indicating data resources allocated to the wireless device in a downlink data channel. The grant comprises a second indicator indicating whether control signaling resources configured for the wireless device are used for data transmission to the wireless device or are not used for data transmission to the wireless device.

According to a tenth aspect there is presented a computer program for receiving granting o resources from a network node, the computer program comprising computer program code which, when run on processing circuitry of a wireless device, causes the wireless device to perform a method according to the sixth aspect.

According to an eleventh aspect there is presented a computer program product comprising a computer program according to at least one of the fifth aspect and the tenth aspect and a computer readable storage medium on which the computer program is stored. The computer readable storage medium could be a non-transitory computer readable storage medium.

It is to be noted that any feature of the first, second, third, fourth, fifth, sixth seventh, eight, ninth, tenth and eleventh aspects may be applied to any other aspect, wherever appropriate.

Likewise, any advantage of the first aspect may equally apply to the second, third, fourth, fifth, sixth, seventh, eight, ninth, tenth, and/or eleventh aspect, respectively, and vice versa. Other objectives, features and advantages of the enclosed embodiments will be apparent from the disclosure as well as from the drawings.

Generally, all terms used herein are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The concept is now described, by way of example, with reference to the accompanying drawings, in which:

FIG. 1 is a schematic diagram illustrating a communication network according to embodiments;

FIGS. 2, 3, 4, and 5 are flowcharts of methods according to embodiments;

FIG. 6 is a schematic illustration of different sets of configured candidates for aggregation levels of Control Channel Elements according to embodiments;

FIGS. 7 to 14 are schematic illustrations of frequency charts according to embodiments;

FIGS. 15 and 16 are schematic illustrations of usage of search space according to embodiments;

FIG. 17 is a schematic diagram showing functional units of a network node according to an embodiment;

FIG. 18 is a schematic diagram showing functional modules of a network node according to an embodiment;

FIG. 19 is a schematic diagram showing functional units of a wireless device according to an embodiment;

FIG. 20 is a schematic diagram showing functional modules of a wireless device according to an embodiment; and

FIG. 21 shows one example of a computer program product comprising computer readable means according to an embodiment.

### DETAILED DESCRIPTION

The concept will now be described more fully hereinafter with reference to the accompanying drawings, in which certain embodiments of the concept are shown. This concept may, however, be embodied in many different forms and should not be construed as limited to the embodiments set forth herein; rather, these embodiments are provided by way of example so that this disclosure will be thorough and complete, and will fully convey the scope of the concept to those skilled in the art. Like numbers refer to like elements throughout the description. Any step or feature illustrated by dashed lines should be regarded as optional.

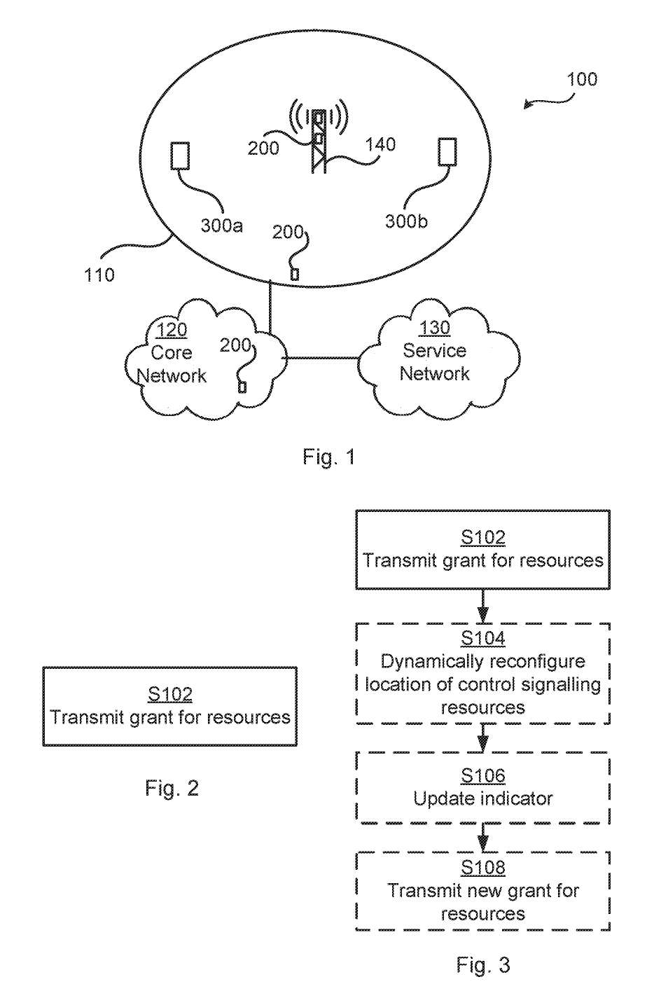

FIG. 1 is a schematic diagram illustrating a communications network 100 where embodiments presented herein can be applied. The communications network 100 comprises at least one network node 200. The functionality of the network node 200 and how it interacts with other entities, nodes, and devices in the communications network 100 will be further disclosed below.

The communications network 100 further comprises at least one radio access network node 140. The at least one radio access network node 140 is part of a radio access network 110 and operatively connected to a core network 120 which in turn is operatively connected to a service network 130. The at least one radio access network node 140 provides network access in the radio access network 110. A wireless device 300a, 300b served by the at least one radio access network node 140 is thereby enabled to access services and exchange data with the core network 120 and the service network 130.

Examples of wireless devices 300a, 300b include, but are not limited to, mobile stations, mobile phones, handsets, wireless local loop phones, user equipment (UE), smartphones, laptop computers, tablet computers, network equipped sensors, wireless modems, and Internet of Things devices. Examples of radio access network nodes 120 include, but are not limited to, radio base stations, base transceiver stations, NodeBs, evolved NodeBs, access points, and access nodes. As the skilled person understands, the communications network 100 may comprise a plurality of radio access network nodes 120, each providing network access to a plurality of wireless devices 300a, 300b. The herein disclosed embodiments are no limited to any particular number of network nodes 200, radio access network nodes 120 or wireless devices 300a, 300b.

The wireless device 300a, 300b accesses services and exchanges data with the core network 120 and the service network 130 by transmitting data in packets to the core network 120 and the service network 130 and by receiving data in packets from the core network 120 and the service network 130 via the radio access network node 140.

Packet latency has above been identified as degrading network performance. One area to address when it comes to packet latency reductions is the reduction of transport time of data and control signaling, by addressing the length of a transmission time interval (TTI). In 3GPP LTE release 8 specifications, a TTI corresponds to one subframe (SF) of length 1 millisecond. One such 1 ms TTI is constructed by using 14 OFDM or SC-FDMA symbols in the case of normal cyclic prefix and 12 OFDM or SC-FDMA symbols in the case of extended cyclic prefix.

According to embodiment disclosed herein the TTIs are shortened by introducing shortened subframes (below denoted short subframes). With a short or shortened (below denoted sTTI), the subframes can be decided to have any duration in time and comprise resources on a number of OFDM or SC-FDMA symbols within a 1 ms subframe. As one example, the duration of a short subframe may be a slot of length 0.5 ms, i.e., seven orthogonal frequency division multiplex (OFDM) symbols or single carrier frequency division multiple access (SC-FDMA) symbols for the case with normal cyclic prefix. As another example, the duration of a short subframe may be a subslot of length 2 or 3 OFDM symbols

Generally, the term resource as herein used is defined by one or more resource elements (see below) in the time/frequency grid used for communications between the network node 200 and the wireless devices 300a, 300b. Some resources are used for control; others are used for data, and yet other could selectively be used for either control or data. Data resources are thus resources dedicated, defined, used, or configured for data. Control signaling resources are thus resources dedicated, defined, used, or configured for control signaling. Some of the resource elements in this time/frequency grid could thus be dedicated, defined, used, or configured for transmitting information of a certain channel (such as PDCCH) and thus define resources for this certain channel (such as PDCCH resources), etc. That is, PDCCH resources are control signaling resources specifically configured for the PDCCH type of control signaling.

By location of a certain resource is meant where this certain resource is located in the time/frequency grid. This location could be a physical location (e.g., relating to a particular frequency) or a logical location (e.g., relating to a particular sCCE index). In more detail, the logical location of a certain resource, or channel, could refer to the set of sCCE indices, indexed for example from 0 to 5, that are spread out to physical locations in the time/frequency grid using some predefined/configured mapping. A set of locations could refer to a set of logical locations, mapped to a set of physical locations.

Further, a certain channel (such as PDCCH) could be configured to use resources at a certain location in the time/frequency grid and the resources at this certain location could be regarded as a region for this channel (such as a PDCCH region)

Further, the terms short Physical Downlink Shared Channel (sPDSCH) and short Physical Uplink Shared Channel (sPUSCH) will hereinafter be used to denote the downlink and uplink physical shared channels with short SFs, respectively. Similarly, short Physical Downlink Control Channel (sPDCCH) is used to denote downlink physical control channels with short SFs, sDCI is used to denote short Downlink Control Information, and sCCE is used to denote a short Control Channel Element.

The available time/frequency resources should be efficiently shared between data transmission and control signaling. Existing ways of operation include time-division multiplex as used by PDCCH, and frequency-division multiplex, as used by ePDCCH. For the sPDCCH, it could be desired to have an efficient utilization of the resources, not being pre-defined multiplex in time or frequency, while limiting the amount of control information sent.

A pure Time Division Multiplexing (TDM) solution, as for PDCCH, would assign a full symbol for control signaling, which leads to a high overhead, e.g. 50% when the total TTI length is 2 symbols.

A pure Frequency Division Multiplexing (FDM) solution, as for EPDCCH, would require waiting until the end of the TTI before control signaling can be decoded, and is thus not desirable for low latency.

There is thus a need for mechanisms that can handle even more flexible allocations, efficiently sharing data and control, and having a low control overhead.

The embodiments disclosed herein therefore relate to mechanisms for transmitting grant for resources to a wireless device 300a and for receiving granting of resources from a network node 200. In order to obtain such mechanisms there is provided a network node 200, a method performed by the network node 200, a computer program product comprising code, for example in the form of a computer program, that when run on processing circuitry of the network node 200, causes the network node 200 to perform the method. In order to obtain such mechanisms there is further provided a wireless device 300a, a method performed by the wireless device 300a, and a computer program product comprising code, for example in the form of a computer program, that when run on processing circuitry of the wireless device 300a, causes the wireless device 300a to perform the method.

Even though longer length can be considered, main candidate lengths for sPDCCH in time domain are 1 or 2 OFDM symbols for sTTI operation. The Resource Elements (REs) of a Physical Resource Block (PRB) in a given OFDM symbol of the sTTI can build at least one short Resource Element Group (sREG). The number of REs in an sREG may be variable in order to provide allocation flexibility and to support good frequency diversity.

For that, in some examples, two sREG configuration options for sPDCCH are defined; PRB based sREG, which means that an sREG is built up with the complete number of REs in a PRB within 1 OFDM symbol (i.e. 12 REs per sREG for 1 OFDM symbol), or a fractioned PRB based sREG, which means that the number of REs in a PRB within 1 OFDM symbol is split and assigned to an sREG (e.g. 6 REs per sREG).

Thus, up to two sREG groups can be configured for sPDCCH with 1 OFDM symbol and up to four sREG groups can be configured for sPDCCH with 2 OFDM symbols. When an sREG only spans a single OFDM symbol this enables to easily extend the sPDCCH design to more OFDM symbols in the time domain. Following this principle (i.e. only one OFDM symbol spanned by an sREG), one can consider the alternative fractioned PRB based sREG in which resource elements of a OFDM symbol would split in more than two sREG for instance.

In other examples, 1 OFDM symbol sPDCCH is defined for Cell-Specific Reference Signal (CRS) based transmissions due to the advantage of early decoding for 2 OFDM symbol sTTI, while 2 or more OFDM symbol sPDCCH can be configured for slot TTI. As an alternative for 2 OFDM symbol sTTI configuration, 2 or more OFDM symbol sPDCCH can be used to allow a small sTTI band, i.e. to limit the number of frequency resources used for sTTI operation.

In further examples, for Demodulation reference signal (DMRS) based transmissions with 2 OFDM symbol sTTI, assuming a design based on DMRS pairs in time domain as in legacy LTE, a 2 OFDM symbol sPDCCH is defined, since wireless devices need anyway to wait for the end of the sTTI for channel estimation. In that case DMRS is thus not shared between sPDCCH and sPDSCH in a given PRB of the sTTI. This gives more freedom for applying beamforming for sPDCCH. For DMRS with 1-slot sTTI, a 2 symbols sPDCCH is suitable. One DMRS pair for 1-slot TTI is preferred to be able to do channel estimation for sPDCCH and early sPDCCH decoding.

Thereby, considering the presence of potential reference signals in an sTTI such as DMRS, CRS or Channel State Information-Reference Signals (CSI-RS), those REs occupied by these signals within a PRB are not used for a given sREG.

The number of sREG required to build up an sCCE for a given sPDCCH could vary as well as their placement scheme along the frequency resources used for sTTI operation. Thus, in some examples, an sCCE is defined to be composed ideally by 36 REs (like an eCCE or a CCE). For that, an sCCE could be composed by either PRB based sREG or fractioned PRB based sREG relying on the number of OFDM symbols assigned for sPDCCH, as further described below.

In order to achieve efficient good frequency diversity, or a more localized placement, localized and distributed placement schemes of sREG building up the same sCCE could be defined as follows.

In a localized scheme, sREGs building the same sCCE can be localized in frequency domain to allow for an sPDCCH resource allocation confined in a limited frequency band. This facilitates the use of beamforming for DMRS based sPDCCH.

In a distributed scheme, a distributed sREG location in frequency domain can be used to allow frequency diversity gains. In this case, multiple wireless devices may have the sREG of their sPDCCH mapped to the same PRB on different REs. Distributing over a wide frequency range also easily makes the sPDCCH fit into one single OFDM symbol. For wireless devices with DMRS based demodulation, user-specific beamforming is not recommended with distributed sCCE locations.

In further examples, schemes described below for building sCCE based on 1 OFDM symbol sPDCCH and 2 OFDM symbol sPDCCH can be used for CRS and DMRS transmissions.

Likewise, the following considerations could be taken. Firstly, wireless devices using CRS and wireless devices using DMRS can coexist on the same sTTI, since the sPDCCH design is the same. Secondly, if both wireless devices using CRS and wireless devices using DMRS are given DCI in the same PRB, wireless devices using CRS need to be indicated with this. Then the wireless devices using CRS know that some REs are not used for sCCE. Otherwise, CRS and DMRS users have to be sent DCI in different PRBs.

In some examples, the number of sREG building up an sCCE varies with configuration. For example, the ideal definition of 36 RE to build up an sCCE as above, leads to an sCCE consisting of 6 sREG. But if 6 sREG are used in a scenario with DMRS added, then less RE are available to use for sCCE. Then a higher number of sREG can be used to build up an sCCE in certain scenarios, e.g. using 8 sREG when having DMRS present.

At least one set of PRB that can be used for sPDCCH is configured per wireless device. It could be recommendable to support the configuration of several sets of PRBs used for sPDCCH so as to configure one set of PRBs following the localized sPDCCH mapping and another set with the distributed mapping. The wireless device would monitor both sets and the network node could select the most favorable configuration/PRB set for a given sTTI and wireless device.

In some examples, the set of PRB assigned for the sPDCCH, which includes PRBs (not necessarily consecutive) from the available sTTI band, are configured via radio resource control (RRC) signaling. However, it can comprise a potential resource allocation refinement in the slow DCI transmitted in the PDCCH, e.g. a reduced set of PRBs or a specific set in case that several sPDCCH sets were defined. A system bandwidth of 10 MHz (i.e. 50 PRBs) could be used, of which a set of 18 PRBs (not necessarily consecutive physical PRBs) is assigned by the network node for the sPDCCH.

In some examples, the set of PRBs for the sPDCCH are configured independently, e.g. as a PRB bitmap. In other examples, the set of PRBs for the sPDCCH is configured based on groups of PRBs. One example of an already defined group of PRBs in LTE is called resource block group or RBG and can be used as basis in the herein disclosed sPDCCH mapping. Then all PRBs within the same PRB group, e.g. RBG, are jointly used. In other examples, wider groups than the RBG used in LTE are used in order to use fewer bits in the bitmap. Here, a short RBG (sRBG) can be used that is defined as an integer multiple of RBG.

In some examples, the PRBs or groups of PRBs included in the configured PRB set may be ordered according to a sequence signaled to the wireless device before mapping the sPDCCH to them.

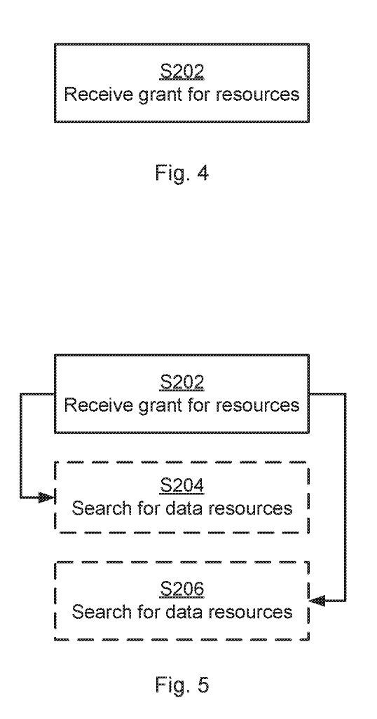

FIGS. 2 and 3 are flow charts illustrating embodiments of methods for transmitting grant for resources to a wireless device 300a as performed by the network node 200. FIGS. 4 and 5 are flow charts illustrating embodiments of methods for receiving granting of resources from a network node 200 as performed by the wireless device 300a. The methods are advantageously provided as computer programs 2120a, 2120b.

Reference is now made to FIG. 2 illustrating a method for transmitting grant for resources to a wireless device 300a as performed by the network node 200 according to an embodiment.

In step S102 the network node 200 transmits the grant for resources to the wireless device 300a.

The grant comprises a first indicator indicating data resources allocated to the wireless device 300a in a downlink data channel.

The grant comprises a second indicator indicating whether control signaling resources configured for the wireless device 300a are used for data transmission to the wireless device 300a or are not used for data transmission to the wireless device 300a.

Reference is now made to FIG. 3 illustrating methods for transmitting grant for resources to a wireless device 300a as performed by the network node 200 according to further embodiments. It is assumed that step S102 is performed as described above with reference to FIG. 2 and a thus repeated description thereof is therefore omitted.

According to some aspects the network node 200 is configured to dynamically reconfigure the control signaling resources. Hence, according to an embodiment the network node 200 is configured to perform steps S104, S106, S108:

S104: The network node 200 dynamically reconfigures location of the control signaling resources

S106: The network node 200, in response to having performed step S104, updates the second indicator according to the reconfigured location of the control signaling resources.

S108: The network node 200 transmits a new grant for resources to the wireless device 300a, where the new grant comprises the updated second indicator.

In this respect, the new grant for resources should be interpreted as a further grant for resources or a future grant for resources, and not as an update of a previously transmitted grant for resources.

Further embodiments relating to the network node 200 and the methods performed by the network node 200 will be disclosed below.

Reference is now made to FIG. 4 illustrating a method for receiving granting of resources from a network node 200 as performed by the wireless device 300a according to an embodiment.

In step S202 the wireless device 300a receives the grant for resources from the network node 200.

As disclosed above, the grant comprises a first indicator indicating data resources allocated to the wireless device 300a in a downlink data channel.

As disclosed above, the grant comprises a second indicator indicating whether control signaling resources configured for the wireless device 300a are used for data transmission to the wireless device 300a or are not used for data transmission to the wireless device 300a.

Reference is now made to FIG. 5 illustrating methods for receiving granting of resources from a network node 200 as performed by the wireless device 300a according to further embodiments. It is assumed that step S202 is performed as described above with reference to FIG. 4 and a thus repeated description thereof is therefore omitted.

There may be different ways for the wireless device 300a to act once having received the grant for resources in step S202.

According to some embodiments the wireless device 300a searches for the data resources. In some aspects the interpretation made by the wireless device 300a of the first indicator will depend on the resources configured for control signaling. Hence, according to an embodiment the wireless device 300a is configured to perform step S204:

S204: The wireless device 300a searches for the data resources according to the first indicator and the control signaling resources.

The data resources are then defined by the control signaling resources excluding resources thereof configured for control signaling.

In some aspects, the resources configured for control signaling that are used for data transmission to the wireless device 300a include only the resources partly used by the message in which the grant for resources is transmitted. Particularly, according to an embodiment when the control signaling resources configured for the wireless device 300a are used for data transmission to the wireless device 300a, the control signaling resources that are used for data transmission to the wireless device 300a include only resources partly used by the grant for resources.

In some aspects, the interpretation made by the wireless device 300a of the first indicator will depend on first indicator and the second indicator. Hence, according to an embodiment the wireless device 300a is configured to perform step S206:

S206: The wireless device 300a searches for the data resources according to the first indicator and the second indicator.

In some aspects, the resources configured for control signaling but that are used for the data channel (i.e. used for data transmission) are the resources among the control signaling resources that have a physical position starting after the position of the resources used for resources used by the grant for resources if the wireless device 300a is indicated that the resources configured for control signaling are used for data transmission. Hence, according to an embodiment when the control signaling resources configured for the wireless device 300a are used for data transmission to the wireless device 300a, the control signaling resources configured for the wireless device 300a that are used for data transmission to the wireless device 300a are defined as those of the control signaling resources that have a physical position starting after resources used by the grant for resources.

Further embodiments applicable to the network node 200, the methods performed by the network node 200, the wireless device 300a, and the methods performed by the wireless device 300 will be disclosed next.

In some aspects, the resources configured for control signaling that are used for data transmission to the wireless device 300a start from a logical location after the grant for resources in the resources partly used by the grant for resources and last until the end of resources Where the grant for resources was found by the wireless device 300a. Hence, according to an embodiment where the control signaling resources configured for the wireless device 300a are used for data transmission to the wireless device 300a, the control signaling resources that are used for data transmission to the wireless device 300a start from a logical location after the grant for resources in resources partly used by the grant for resources until the end of all the control signaling resources.

According to a further embodiment where the grant for resources is transmitted at a logical location and where the control signaling resources configured for the wireless device 300a are used for data transmission to the wireless device 300a, the control signaling resources that are used for data transmission to the wireless device 300a are determined by the logical location of the grant for resources in resources partly used by the grant for resources. Here, location could be interpreted as defining both position and aggregation level, or position and size, or start and stop, or per aggregation level candidate. Further, the control signaling resources that are used for data transmission to the wireless device 300a could be determined to start from a logical location after the grant for resources in resources partly used by the grant for resources until the end of all the control signaling resources.

According to embodiments the first indicator is provided as a bitmap where each bit represents one or more PRBs. Each bit could represent one or more Resource Block Groups, where each Resource Block Group (RBG) could comprise one or more PRBs.

According to embodiments the second indicator is provided by at least one indicator bit.

According to embodiments the grant for resources is provided in an sTTI frequency band.

According to embodiments the grant for resources is provided in an sDCI, message.

According to embodiments the grant for resources is provided on an sPDCCH.

According to embodiments the wireless device 300a is configured with at least one sPDCCH set of locations to search for the sDCI.

According to embodiments the resources are downlink data provided in an sPDSCH region. That is, the resources are used for downlink data provided in an sPDCCH region.

According to embodiments when the control signaling resources configured for the wireless device 300a are not used for data transmission to the wireless device 300a, the wireless device 300a is configured to not use any configured sPDCCH resources for sPDCCH.

According to embodiments when the control signaling resources configured for the wireless device 300a are used for data transmission to the wireless device 300a, the wireless device 300a is configured to use configured sPDCCH resources after the sDCI message for sPDCCH.

Further aspects of the above embodiments applicable to the network node 200, the methods performed by the network node 200, the wireless device 300a, and the methods performed by the wireless device 300 will be disclosed next.

The existing physical layer downlink control channels PDCCH and ePDCCH, are used to carry Downlink Control Information (DCI) such as scheduling decisions for UL and DL and power control commands. To efficiently indicate to the wireless devices which resources are being used, the location of the scheduled resources could be dependent on the location and aggregation level of the DCI message. In terms of the above disclosed bitmap, the DCI message sent from the network node to the wireless device could thus comprise a bitmap for the data channel, sPDCCH, similarly as done in DL resource allocation type 0. A resource allocation type is defined in 3GPP specifications and specifies allocation of resource blocks for each transmission. For LTE there are three different allocation types which use pre-defined procedures: allocation type 0, 1 and 2. In DL resource allocation type 0, each bit in the bitmap refers to one resource block group (RBG). For a 10 MHz system, each RBG consists of 3 PRB, leading to 17 bits in the bitmap. In order to reduce the number of bits in the DCI message, the bitmap points to an sRBG. To easily be able to schedule wireless devices using sTTI together with wireless devices using TTI, the sRBG could be an integer multiple of the RBG. For example, 1 sRBG=2 RBG=6 PRB.

Each wireless device is, as described previously, configured with one or more sets of sPDCCH resources. These consist of sets of PRBs that can potentially contain DCI messages.

When the wireless device reads its decoded DCI, it looks at the bitmap pointing to sRBG indices. The wireless device then determines which PRBs correspond to the sRBG indices assigned for sPDSCH transmission. The PRBs not overlapping with the sPDCCH resources from where the wireless device decoded its DCI are then used for sPDSCH data to the wireless device.

In terms of the above disclosed at least one indicator bit, the PRBs that are overlapping with the sPDCCH resources are handled in a different way. The at least one indicator bit could be comprised in the DCI message. According to some aspects, where there is a single indicator bit, the indicator bit could represent the following two cases depending on the value (“0” or “1”) of the indicator bit:

Indicator bit value “0”: The wireless device 300a is not to use any configured sPDCCH resources for sPDSCH. None of the resources that can potentially be used by the current sPDCCH set are used by this wireless device.

Indicator bit value “1”: The wireless device 300a is to use configured sPDCCH resources after the sDCI for sPDSCH. The wireless device knows the location of the sPDCCH set, and knows that resources after the present sDCI are used for data transmission targeted to this wireless device.

With this interpretation of a “1”, if many wireless devices share the same configured sPDCCH resources, only one wireless device 300a can be given a “1”, since only one wireless device 300a can have its DCI placed last.

Alternative interpretations of a “1” for the “use sPDCCH” indicator bit are possible. In some aspects, a “1” for this field is by the wireless device interpreted as the usage of the remaining resource elements in a PRB partly used by the sPDCCH. This is useful in case of an sREG allocation that only partly uses the resource elements of a PRB. The remaining resource elements of PRBs partly occupied by the sPDCCH of a wireless device can be occupied by the sPDSCH for the same wireless device if the field “use sPDCCH” is set to “1” in the DCI of this wireless device. With this interpretation of the “use sPDCCH” indicator bit, multiple wireless devices can have this field set to 1 if their DCI actually uses different PRBs and even if these wireless devices have the same configured sPDCCH resources.

According to some aspects, an indicator bit of the at least one indicator bit could represent the following two cases depending on the value (“0” or “1”) of the indicator bit: indicator bit value “1”: The wireless device 300a is not to use any configured sPDCCH resources for sPDSCH.

Indicator bit value “0”: The wireless device 300a is to use configured sPDCCH resources for sPDSCH.

The at least one indicator bit could be one, two, three or more bits. The skilled person can apply the similar reasoning as above for multiple bit scenarios.

Depending on how the sPDCCH set is configured, the frequency placement of these sPDSCH data will differ. E.g., if the sPDCCH set refers to a distributed set, then the sPDSCH data will also be distributed over many PRBs. A single wireless device can have resources allocated both from the indicator bit and the sRBG bitmap.

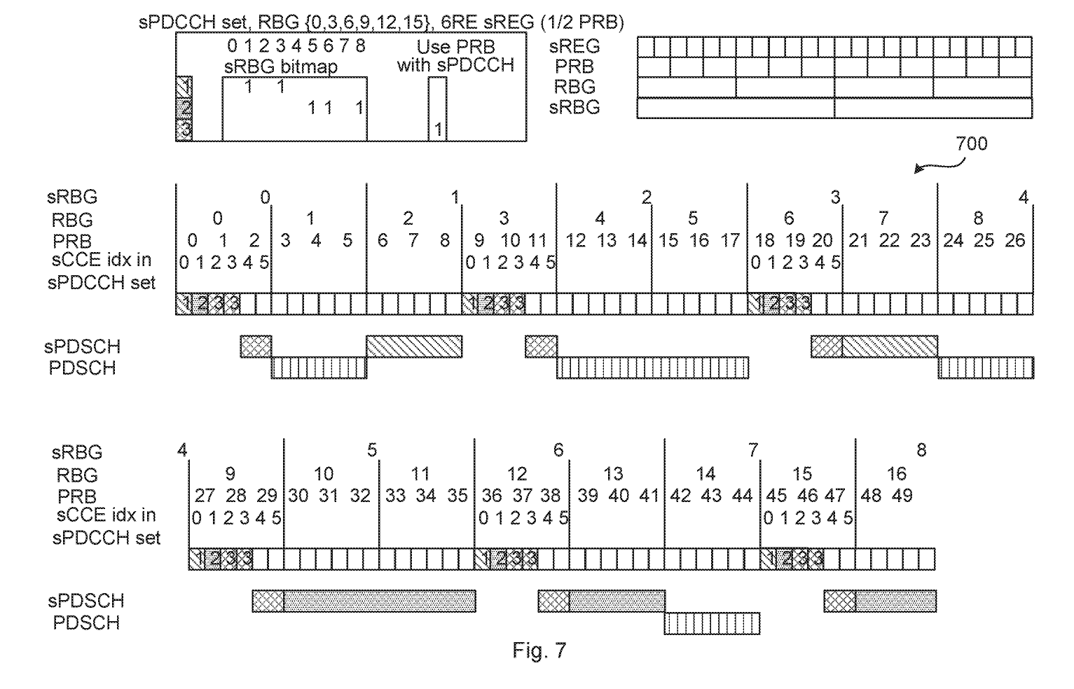

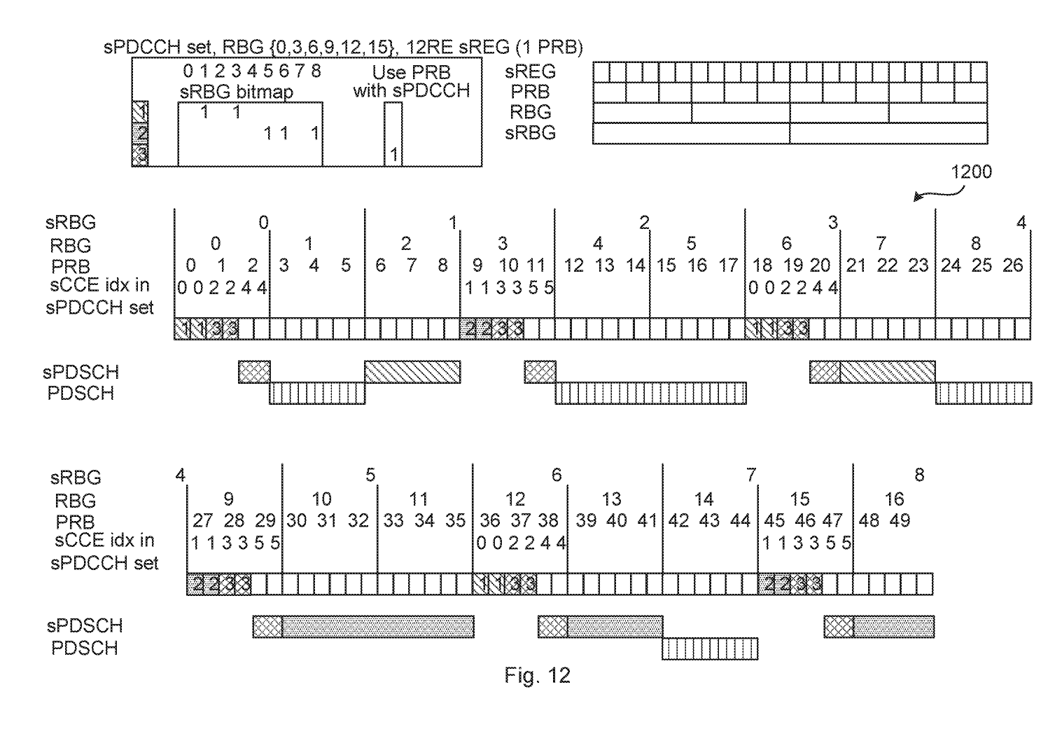

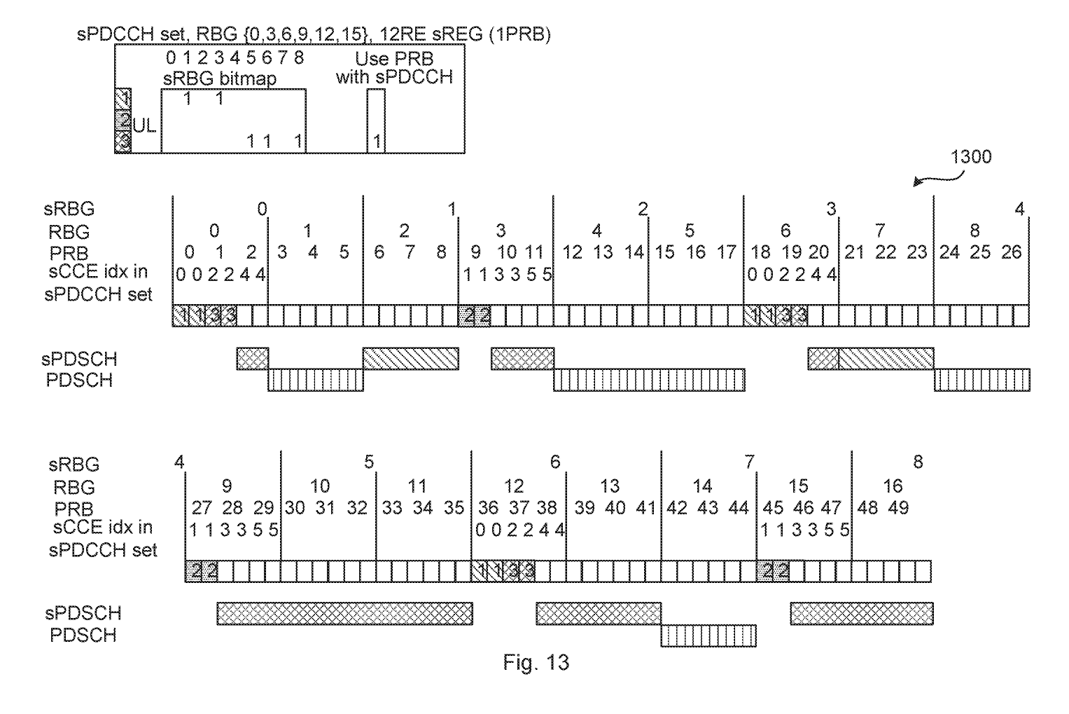

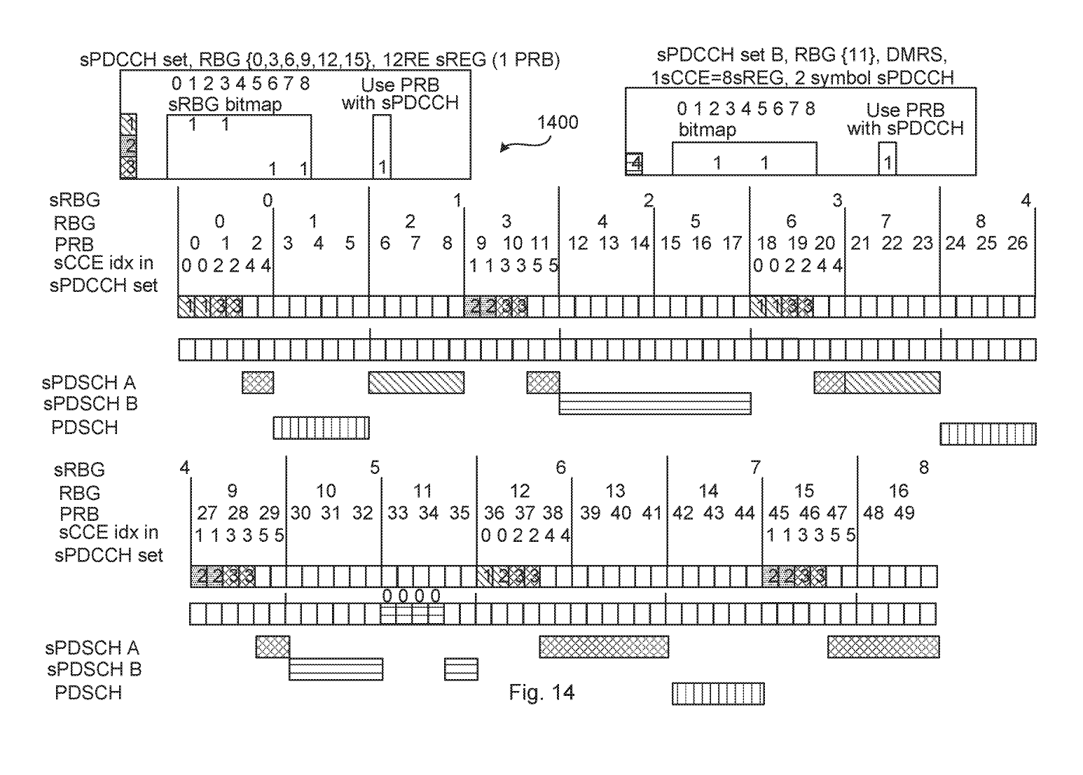

Illustrative examples of at least some of the herein disclosed embodiments will now be presented. The illustrative examples are using a 10 MHz LIE system, with 50 PRB. With downlink resource allocation type 0, the PRBs are grouped together in RBGs, each of 3 PRB. To co-exist with legacy or sub-frame length LTE (i.e., LTE which is using sub-frame length TTI). while keeping the number of bits in the allocation low, an sRBG is used as a multiple of RBGs. Here, the double size is used, thus, 1 sRBG=6 PRB. Each box in FIGS. 7-14 shows a half PRB; one sREG is half a PRB in FIGS. 7-11 and a full PRB in FIGS. 12-14.

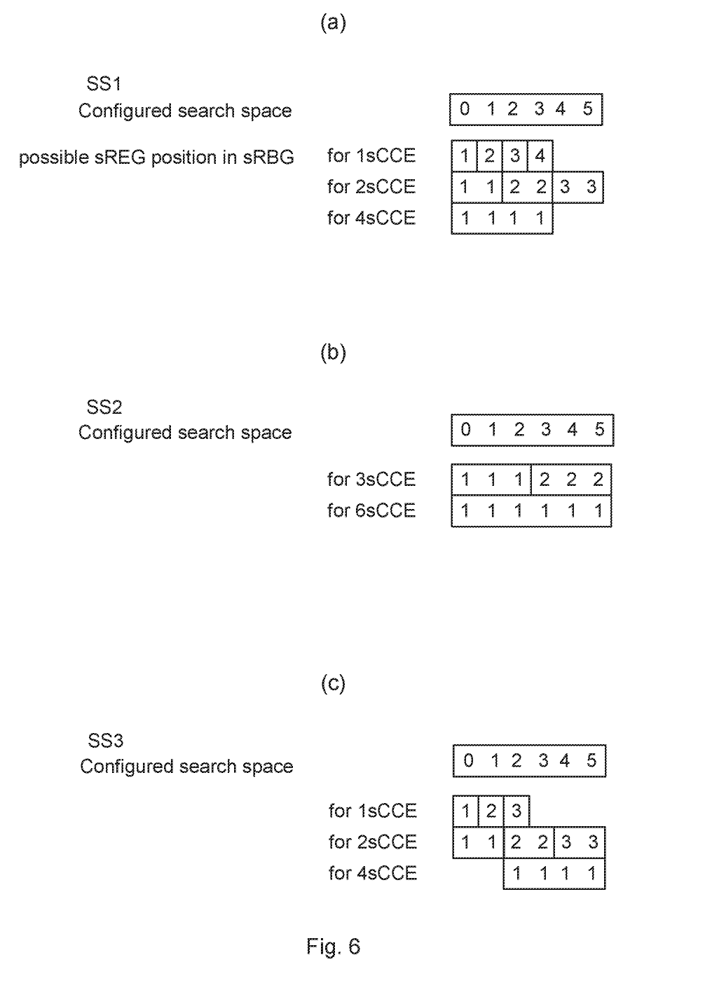

FIG. 6 at (a), (b), and (c) shows three examples SS1, SS2, SS3 of configured candidates for aggregation levels of 1sCCE, 2sCCE and 4sCCE in (a), for 3sCCE and 6sCCE in (b), and for 1sCCE, 2sCCE and 4sCCE in (c). The exact choice of number of candidates and location of them can either be standardized or signaled from the network node.

In some embodiments, the number of sREG or resource elements per sREG changes according to the size of the sRBG. It could be favorable to try to fill up the configured sPDCCH resources as much as possible so that no small parts are left unused (which may not be usable for data if only UL transmission is scheduled). Then, depending on the size of the chosen sRBG, the supported aggregation levels could be changed. For example, two sets of aggregation level 3 would each fill up exactly half of the resources (where each aggregation level 3 uses 3 sCCE, which is 3 out of the 6 available sCCE locations defined by the configured sPDCCH resources), and an aggregation level 6 would fill up all resources (where all available sCCE locations of the configured sPDCCH resources are used). See example in FIG. 6(b), where the shown 3sCCE and 6sCCE search spaces could be added to the previous (i.e., as in FIG. 6(a)), or replacing some of them.

FIG. 7 illustrates a first example of a frequency chart 700 where three wireless denoted UE1, UE2 and UE3 are given the same sPDCCH set of RBG: {0,3,6,9,12,15}. To achieve good frequency diversity, the placement is spread out in frequency. One sCCE then here consists of 6 sREG. sCCE number 0 consists of the 6 sREG marked with “CCE idx 0”, and similarly for the other CCEs.

UE1 finds its sDCI at the first isCCE position in FIG. 6(a). In the bitfield, it is given sRBG 1 and 3. UE1 then gets the striped regions in the frequency chart. For sRBG 1, the second part (RBG 3) is used by the sPDCCH set, so UE1 cannot use that. Similarly for the first half of sRBG3 (RBG 6). Thus, UE1 gets allocation at RBG 2 and RBG 7.

Similarly, UE2 finds its sDCI at the second isCCE position in FIG. 6(a). It is given sRBGs 5, 6, 8. Following the same procedure as for UE1, UE2 gets full sRBG 5 and sRBG 8 since no sPDCCH set is configured there, and half sRBG 6. See the dotted regions in the in the frequency chart 700.

UE3 decodes an sDCI at the second 2sCCE position from FIG. 6(a). It has no assigned bits in the bitfield, but has a “1” in the field denoting use of remaining sPDCCH resources. This field is to be interpreted in combination with the sRBG definition and the entire set of configured sPDCCH PRBs, meaning that UE3 is allowed to use the remaining PRBs configured with sPDCCH in a given sRBG after the sPDCCH PRBs where UE3 found its sDCI. I.e., UE3 uses the CCE indices above the current CCE index. See the cross-striped regions in the in the frequency chart

After assigning UE1, UE2, UE3, RBG 1, 4, 5, 8 and 14 are not used. These are then free to schedule sub-frame length LTE transmission on, e.g. using resource allocation type 0.

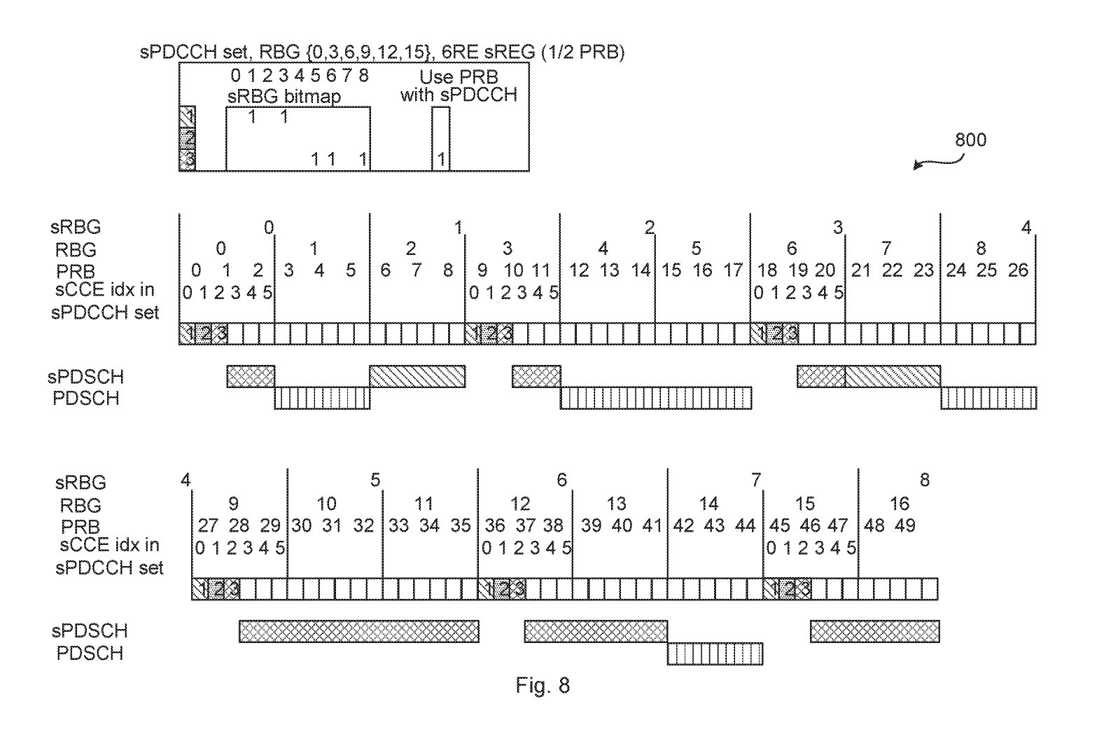

FIG. 8 illustrates a second illustrative example of a frequency chart 800 being similar to the first illustrative example, where UE2 receives an sDCI with an UL allocation, and thus has no scheduled sPDCCH resources. UE3 has resource blocks assigned with the bitmap, in addition to the resources given by the “1” in the field denoting use of remaining sPDCCH resources. UE3 is also given a 1sCCE aggregation, and thus not only uses remaining PRBs after the given PRB, but also remaining part of the current PRB (all sCCE indices above the current sCCE index).

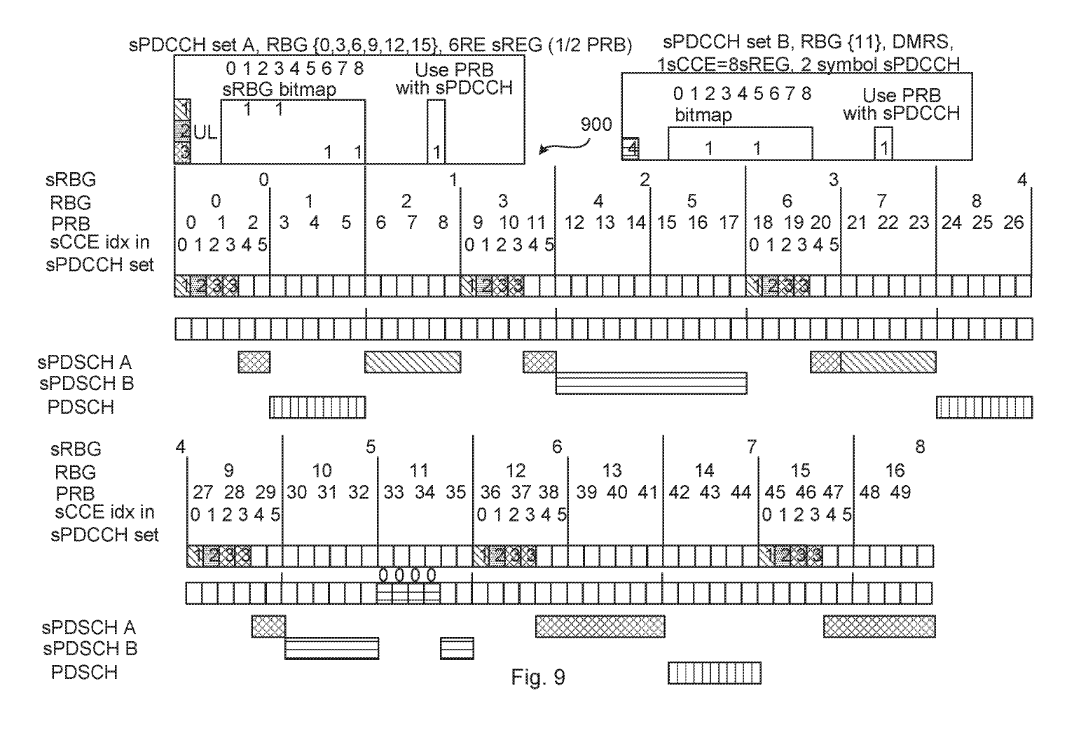

FIG. 9 illustrates a third illustrative example of a frequency chart 900 where one group of wireless devices (defined by UE1, UE2, UE3) gets one sPDCCH set A. and another wireless device (denoted UE 4) gets another sPDCCH set B, configured as “Use RBG 11”. Further, sPDCCH set A uses sPDCCH in the first symbol of the sTTI, thus using 6 sREG to build up an sCCE. Further, sPDCCH set B uses DMRS demodulation, and sPDCCH in the first two symbols of the sTT1. Then each marked box in the frequency chart 900 represents two sREG. Since the overhead with DMRS demodulation is larger due to the added DMRS, one sCCE is here selected to consist of 8 sREG (i.e. 4 boxes in the frequency chart). Although the two last sCCE indices are not used here for a decoding candidate, they may still be included in the sPDCCH configuration, in order to have efficient utilization of the resources together with DL allocation type 0.

UE1, UE2 and UE3 get similar allocation as in the second illustrative example 2, but UE4 has now been allocated sRBG 5. UE3 uses the remaining resources of PRB 11, as well as all resources of PRB 10. The third illustrative example shows that it is possible to multiplex CRS-based scheduling, DMRS-based scheduling, as well as sub-frame length LTE transmission.

In the first illustrative example, the DCI of UE 3 contains a field called “Use PRB with sPDCCH”. This field was set to “1” denoting use of remaining sPDCCH resources. In the first illustrative example, this field is to be interpreted in combination with the entire set of configured sPDCCH PRBs.

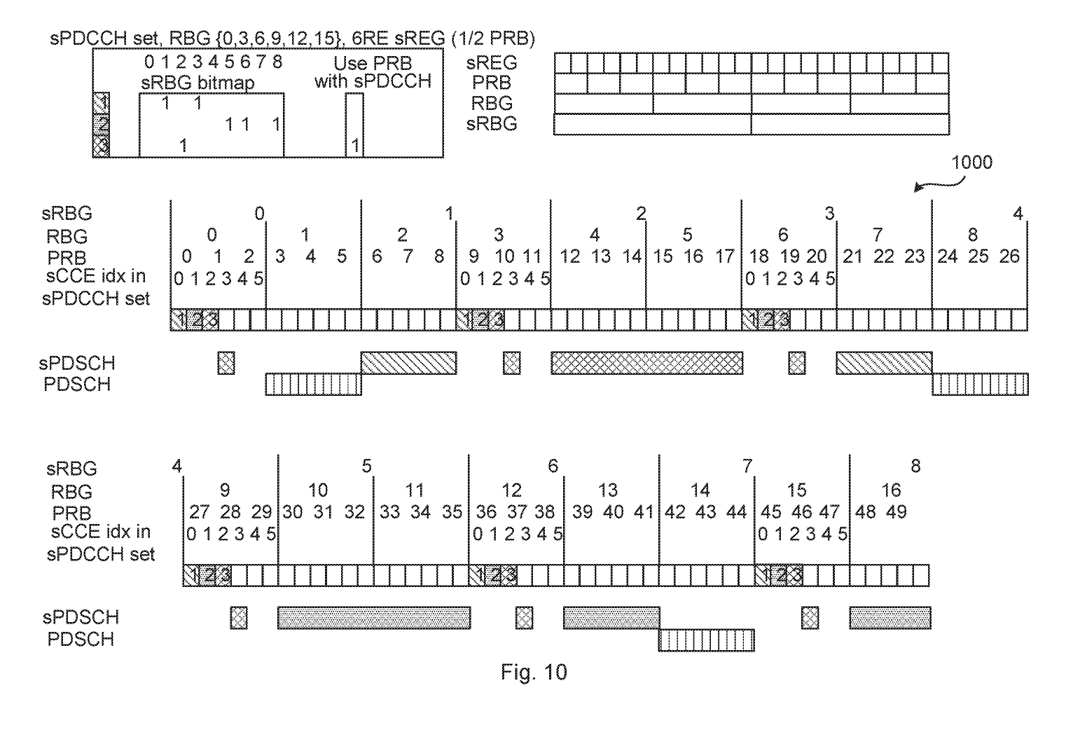

An alternative is to interpret this field independently of sRBG definition and independently of the entire set of configured sPDCCH PRBs. This is covered by the fourth illustrative example as exemplified by the frequency chart 1000 in FIG. 10. In this example wireless devices with al for the field “use PRB with sPDCCH” assume that the remaining resources in the sPDCCH PRBs where sDCI was detected are used for sPDSCH. Wireless devices with a 1 for the field “Use PRB with sPDCCH” cannot assume anything about the usage of the other configured sPDCCH PRBs where an sDCI was not detected. In FIG. 10 this is illustrated for UE3. The sDCI of UE3 uses an aggregation level of 1 which requires 6 sREG that are distributed over the entire bandwidth. This results in that 6 PRBs are needed for the sDCI but only half of the resource elements of these PRBs are actually containing the sDCI. By setting the field “Use PRB with sPDCCH” to 1 the remaining resource elements of these 6 PRBs are used for sPDSCH.

Note that this interpretation of the field “Use PRB with sPDCCH” is compatible with the previously mentioned rule where sPDSCH sRBG based allocation excludes the PRBs configured for sPDCCH. In FIG. 10 this is illustrated for UE1 that is allocated. sRBG 1 for sPDSCH but where the PRBs configured for sPDCCH are removed from the sPDSCH allocation in sRBG 1.

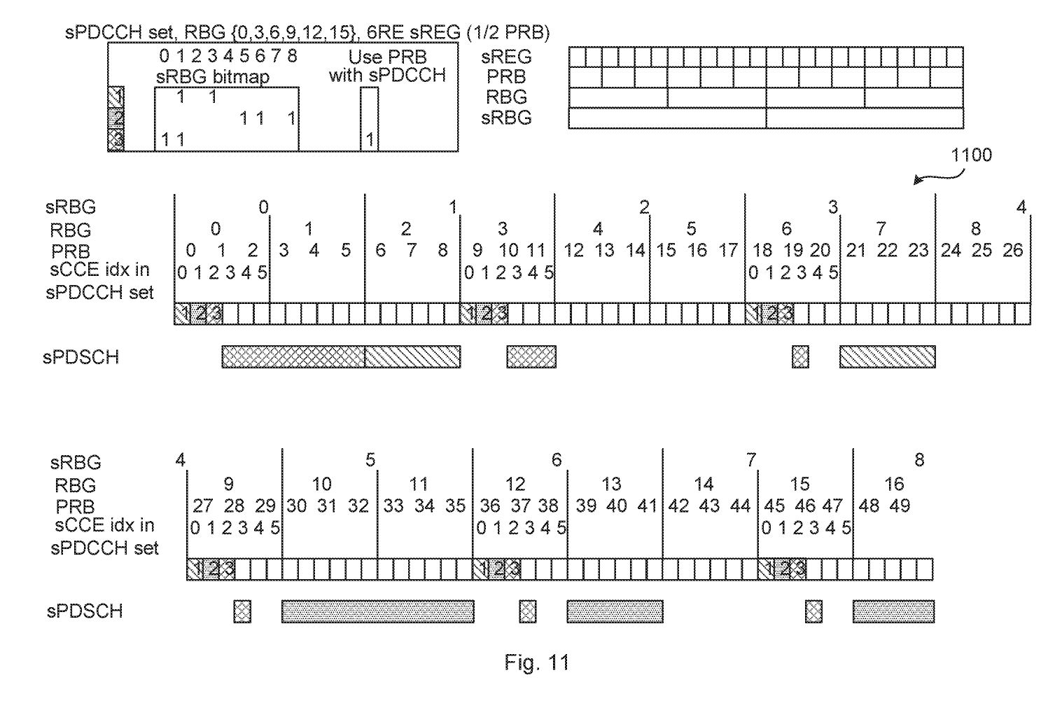

A potential drawback with the alternative PRB-based interpretation of the field “Use PRB with sPDCCH” is that some PRBs in an sRBG can be left unused such as PRB 2, 10. 19, etc. In the fourth illustrative example. To cope with this, the sRBG based allocation for sPDSCH can be interpreted differently when the field “Use PRB with sPDCCH” is set to 1, as in the fifth illustrative example as exemplified by the frequency chart 1100 illustrated in FIG. 11. A wireless device with an allocated sRBG should check if sPDCCH PRBs were configured and contained sDCI for this RBG. If that is the case and the field “Use PRB with sPDCCH” is set to 1″, the wireless device should assume that only the PRBs after the PRBs used for sDCI in this particular sRBG contain sPDSCH. In FIG. 11 UE3 is allocated sRBG 0 and 1 for sPDSCH and sDCI is sent (among others) in PRBs 1 and 10 of those RBGs. Since UE3 has the field “Use PRB with sPDCCH” set to 1″, UE3 knows that sPDSCH is sent in the remaining resources of PRBs 1 and 10 plus the PRBs afterwards, i.e., PRBs 2 to 5 and PRBs 11.

This interpretation of the field “Use PRB with sPDCCH” and the additional interpretation of sRBG based allocation for sPDSCH for wireless devices with the field “Use PRB with sPDCCH” set to 1 are compatible with the previously mentioned rule where sPDSCH sRBG based allocation excludes the PRBs configured for sPDCCH. This is shown in FIG. 11 for UE1 that is allocated sRBG 1 for sPDSCH but removes the PRBs configured for sPDCCH from the sPDSCH allocation in sRBG 1. Thus, in the fifth illustrative example the first half of sRBG 1 is used for UE1's sPDSCH and the few last PRBs of sRBG I is used for the sPDSCH belonging to UE3.

As an alternative to split each PRB into two sREG in frecuency (using 6RE per sREG), the full PRB can be used for sREG (all 12 RE). Then one sCCE will consist of 3sREG instead of 6sREG. FIGS. 12, 13 and 14 show examples of frequency charts 1200, 1300 and 1400 using the same setup as FIGS. 7, 8, and 9, but with this larger sREG size. The same PRB is thus never split between two sCCE indices. Instead, the sCCE indices are placed alternating between the configured groups. The same meaning of the indicator bit can be used, indicating that sCCE indices higher than the current DCI location are used for data.

In the above illustrative examples, one bit is used to indicate whether sCCE indices with higher numbers are being used. Other examples use a somewhat larger control indication, with the result that the number of blind decodes can be limited, as in FIG. 6(c). In FIG. 6(c), a variation of the search space is shown where only two candidates are used for 1sCCE, and the 4sCCE candidate is placed at the highest sCCE indices.

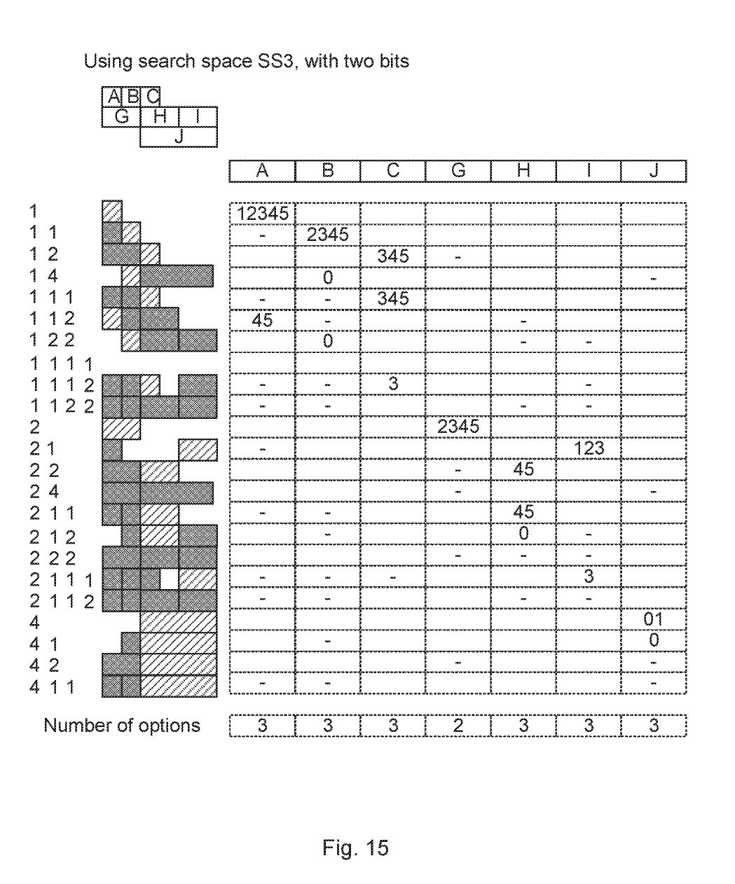

FIG. 15 illustrates a sixth illustrative example. To the left in FIG. 15 are listed all combinations of up to 4 DCI messages together with how these DCI messages may be placed (the “1,1,1,1” option is not possible since only 3 candidates are given in SS3). Solid-colored boxes denote UL grants of DL grants not using sPDCCH resources for data channel. Striped boxes show DL grants where remaining resources are used for data, Using the set given in SS3, the DCI messages cannot always be placed consecutively from the beginning. Instead, there are sometimes unused regions between the DCI messages. (E.g., the “1,1,1,2” option, which has an empty space at sCCE index 3.)

Denoting the decoding candidates A, B, C, G, H, I, J, it is possible to for each of the candidates list the different options for the remaining data region. All candidates need a “-” option, meaning to not use sPDCCH resources, and an additional 1 or 2 options (i.e., in total 2 or 3 options). This can be solved by using an extra bit for the indicator bit (i.e., having two indicator bits).

The present example uses up to 3 decoding candidates for aggregation level 1 and 2, although it is understood that lower as well as higher number of candidates could be used. Lower number of candidates will reduce the number of blind decodes the wireless device needs to perform, but will limit the scheduling flexibility. The aggregation level denotes how many sCCEs that are used on a DCI. By increasing the aggregation level, more resources are used to encode the DCI. The ability to vary the aggregation level thus serves as a form of link adaptation for the control channel.

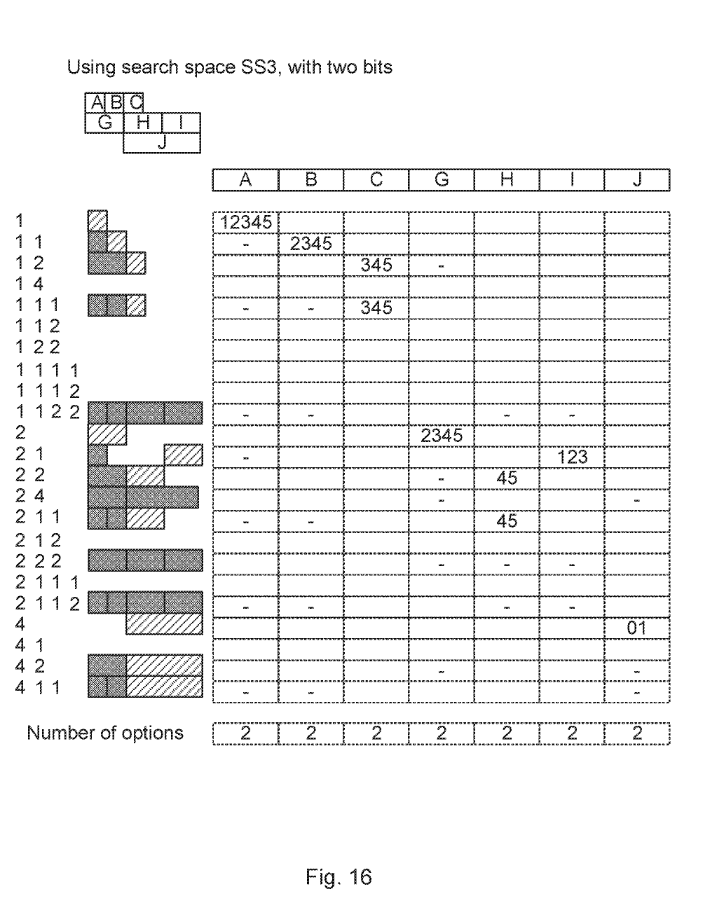

FIG. 16 illustrates a seventh illustrative example using the same setup as the sixth illustrative example, but using one single indicator bit. This results in a similar design as for the first, second, and third illustrative examples. For candidates A-H, the bit indicates to use sCCE indices larger than the sCCE index used for the current sDCI, which is same as for the first, second, and third illustrative examples. For candidates I and J, however, the placement used in the sixth illustrative example (i.e. not simply using higher sCCE indices) is used.

The illustrative examples given above all use an sPDCCH configuration of 6 sCCE. This can be varied to different numbers, both smaller and larger. For different bandwidths than 10 MHz, the RBG size will not be 3 PRB. This may also affect the size of the sPDCCH configuration.

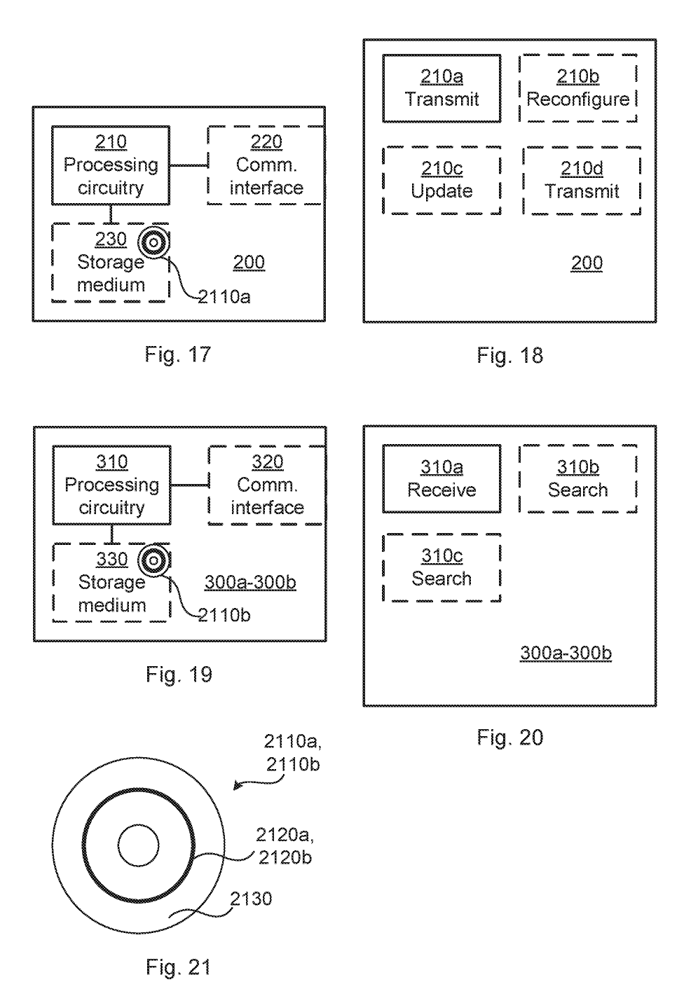

FIG. 17 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 2110a (as in FIG. 21), e.g. In the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, S102-S108, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus, the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200 may further comprise a communications interface 220 for communications with other entities, devices, and nodes of the communications network 100. As such the communications interface 220 may comprise one or more transmitters and receivers, comprising analogue and digital components.

The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 18 schematically illustrates, in terms of a number of functional modules, the components of a network node 200 according to an embodiment. The network node 200 of FIG. 18 comprises a transmit module 210a configured to perform step S102. The network node 200 of FIG. 18 may further comprise a number of optional functional modules, such as any of a reconfigure module 210b configured to perform step S104, an update module 210c configured to perform step S106, and a transmit module 210d configured to perform step S108. In general terms, each functional module 210a-210d may be implemented in hardware or in software. Preferably, one or more or all functional modules 210a-210d may be implemented by the processing circuitry 210, possibly in cooperation with the communications interface 220 and/or the storage medium 230. The processing circuitry 210 may thus be arranged to from the storage medium 230 fetch instructions as provided by a functional module 210a-210d and to execute these instructions, thereby performing any steps of the network node 200 as disclosed herein.

The network node 200 may be provided as a standalone device or as a part of at least one further device. For example, the network node 200 may be provided in a node of the radio access network 110 or in a node of the core network 120. Alternatively, functionality of the network node 200 may be distributed between at least two devices, or nodes. These at least two nodes, or devices, may either be part of the same network part (such as the radio access network 110 or the core network 120) or may be spread between at least two such network parts.

Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 17 the processing circuitry 210 may he distributed among a plurality of devices, or nodes. The same applies to the functional modules 210a-210d of FIG. 18 and the computer program 2120a of FIG. 21 (see below)

FIG. 19 schematically illustrates, in terms of a number of functional units, the components of a wireless device 300a according to an embodiment. Processing circuitry 310 is provided using any combination of one or more of a suitable central processing unit (CPU), multiprocessor, microcontroller, digital signal processor (DSP), etc., capable of executing software instructions stored in a computer program product 2110b (as in FIG. 21), e.g. In the form of a storage medium 330. The processing circuitry 310 may further be provided as at least one application specific integrated circuit (ASIC), or field programmable gate array (FPGA). Particularly, the processing circuitry 310 is configured to cause the wireless device 300a to perform a set of operations, or steps, S202-S206, as disclosed above. For example, the storage medium 330 may store the set of operations, and the processing circuitry 310 may be configured to retrieve the set of operations from the storage medium 330 to cause the wireless device 300a to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The wireless device 300a may further comprise a communications interface 320 for communications with other entities, devices, and nodes of the communications network 100. As such the communications interface 320 may comprise one or more transmitters and receivers, comprising analogue and digital components.

The processing circuitry 310 controls the general operation of the wireless device 300a e,g. by sending data and control signals to the communications interface 320 and the storage medium 330, by receiving data and reports from the communications interface 320, and by retrieving data and instructions from the storage medium 330. Other components, as well as the related functionality, of the wireless device 300a are omitted in order not to obscure the concepts presented herein.

FIG. 20 schematically illustrates, in terms of a number of functional modules, the components of a wireless device 300a according to an embodiment. The wireless device 300a of FIG. 20 comprises a receive module 310a configured to perform step S202. The wireless device 300a of FIG. 20 may further comprise a number of optional functional modules, such as any of a search module 310b configured to perform step S204 and a search module 310c configured to perform step S206. In general terms, each functional module 310a-310c may be implemented in hardware or in software. Preferably, one or more or all functional modules 310a-310c may be implemented by the processing circuitry 310, possibly in cooperation with the communications interface 320 and/or the storage medium 330. The processing circuitry 310 may thus be arranged to from the storage medium 330 fetch instructions as provided by a functional module 310a-310c and to execute these instructions, thereby performing any steps of the wireless device 300a as disclosed herein.

FIG. 21 shows one example of a computer program product 2110a, 2110b comprising computer readable means 2130. On this computer readable means 2130, a computer program 2120a can be stored, which computer program 2120a can cause the processing circuitry 210 and thereto operatively coupled entities and devices, such as the communications interface 220 and the storage medium 230, to execute methods according to embodiments described herein. The computer program 2120a and/or computer program product 2110a may thus provide means for performing any steps of the network node 200 as herein disclosed. On this computer readable means 2130, a computer program 2120b can be stored, which computer program 2120b can cause the processing circuitry 310 and thereto operatively coupled entities and devices, such as the communications interface 320 and the storage medium 330, to execute methods according to embodiments described herein. The computer program 2120b and/or computer program product 2110b may thus provide means for performing any steps of the wireless device 300a as herein disclosed.

In the example of FIG. 21, the computer program product 2110a, 2110b is illustrated as an optical disc, such as a CD (compact disc) or a DVD (digital versatile disc) or a Blu-Ray disc. The computer program product 2110a, 2110b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 2120a, 2120b is here schematically shown as a track on the depicted optical disk, the computer program 2120a, 2120b can be stored in any way which is suitable for the computer program product 2110a, 2110b.

Advantageously these methods, these network nodes, these wireless devices, and these computer programs provide efficient utilization of resources allocated to the wireless device. Advantageously these methods, these network nodes, these wireless devices, and these computer programs provide an efficient system, ensuring resources possible to use for data (such as sPDSCH or PDSCH) if not used by control signaling (such as sPDCCH).

Advantageously these methods, these network nodes, these wireless devices, and these computer programs allow co-existence between wireless device with distributed sPDCCH placement and wireless devices with localized sPDCCH placement.

Advantageously these methods, these network nodes, these wireless devices, and these computer programs allow co-existence between CRS-sPDCCH and DMRS-sPDCCH.

Advantageously these methods, these network nodes, these wireless devices, and these computer programs allow co-existence with wireless devices when using 3GPP allocation type 0. Advantageously the grant for resources as herein defined result in a comparatively low control channel overhead.

The concept has mainly been described above with reference to a few embodiments. However, as is readily appreciated by a person skilled in the art, other embodiments than the ones disclosed above are equally possible within the scope of the concept, as defined by the appended claims.

1-40. (canceled)

41. A method for transmitting a grant for resources to a wireless device, the method comprising a network node:
transmitting the grant for resources to the wireless device;
wherein the grant comprises a first indicator indicating data resources allocated to the wireless device in a downlink data channel; and
wherein the grant comprises a second indicator indicating whether control signaling resources configured for the wireless device are used for data transmission to the wireless device or are not used for data transmission to the wireless device.

42. The method of claim 41, further comprising dynamically reconfiguring location of the control signaling resources; and in response thereto:
updating the second indicator according to the reconfigured location of the control signaling resources; and
transmitting a new grant for resources to the wireless device comprising the updated second indicator.

43. The method of claim 41, wherein, when the control signaling resources configured for the wireless device are used for data transmission to the wireless device, the control signaling resources that are used for data transmission to the wireless device include only resources partly used by the grant for resources.

44. The method of claim 41, wherein, when the control signaling resources configured for the wireless device are used for data transmission to the wireless device, the control signaling resources that are used for data transmission to the wireless device start from logical location after the grant for resources in resources partly used by the grant for resources and last until the end of resources where the grant for resources was found by the wireless device.

45. The method of claim 41:
wherein the grant for resources is transmitted at a logical location; and
wherein, when the control signaling resources configured for the wireless device are used for data transmission to the wireless device, the control signaling resources that are used for data transmission to the wireless device are determined by the logical location of the grant for resources in resources partly used by the grant for resources.

46. The method of claim 45, wherein the control signaling resources that are used for data transmission to the wireless device are determined to start from a logical location after the grant for resources in resources partly used by the grant for resources until the end of all the control signaling resources.

47. The method of claim 41, wherein the first indicator is provided as a bitmap, where each bit represents one or more Physical Resource Blocks.

48. The method of claim 47, wherein each bit represents one or more Resource Block Group, each Resource Block Group comprising one or more Physical Resource Blocks.

49. The method of claim 41, wherein the second indicator is provided by at least one indicator bit.

50. The method of claim 41, wherein the grant for resources is provided in a short Transmission Time Interval frequency band.

51. The method of claim 41, wherein the grant for resources is provided in a short Downlink Control Information (sDCI) message.

52. The method of claim 41, wherein the grant for resources is provided on a short Physical Downlink Control Channel (sPDCCH).

53. The method of claim 51:
wherein the grant for resources is provided on a short Physical Downlink Control Channel (sPDCCH); and
wherein the wireless device is configured with at least one sPDCCH set of locations to search for the sDCI.

54. The method of claim 41, wherein the resources are downlink data provided in a short Downlink Shared Channel (sPDSCH) region.

55. The method of claim 51:
wherein the grant for resources is provided on a short Physical Downlink Control Channel (sPDCCH);
wherein the resources are downlink data provided in a short Downlink Shared Channel (sPDSCH) region; and
wherein, when the control signaling resources configured for the wireless device are not used for data transmission to the wireless device, the wireless device is configured to not use any configured sPDCCH resources for sPDSCH.

56. The method of claim 51:
wherein the grant for resources is provided on a short Physical Downlink Control Channel (sPDCCH); and
wherein the resources are downlink data provided in a short Downlink Shared Channel (sPDSCH) region; and
wherein, when the control signaling resources configured for the wireless device are used for data transmission to the wireless device, the wireless device is configured to use configured sPDCCH resources after the sDCI message for sPDSCH.

57. A method for receiving granting of resources from a network node, the method comprising a wireless device:
receiving a grant for resources from the network node;
wherein the grant comprises a first indicator indicating data resources allocated to the wireless device in a downlink data channel; and
wherein the grant comprises a second indicator indicating whether control signaling resources configured for the wireless device are used for data transmission to the wireless device or are not used for data transmission to the wireless device.

58. The method of claim 57, further comprising searching for the data resources according to the first indicator and the control signaling resources.

59. The method of claim 58, wherein the data resources are defined by the control signaling resources excluding resources thereof configured for control signaling.

60. The method of claim 57, wherein, when the control signaling resources configured for the wireless device are used for data transmission to the wireless device, the control signaling resources that are used for data transmission to the wireless device include only resources partly used by the grant for resources.

61. The method of claim 60, further comprising searching for the data resources according to the first indicator and the second indicator.

62. The method of claim 61, wherein, when the control signaling resources configured for the wireless device are used for data transmission to the wireless device, the control signaling resources configured for the wireless device that are used for data transmission to the wireless device are defined as those of the control signaling resources that have a physical position starting after resources used by the grant for resources.

63. The method of claim 57, wherein, when the control signaling resources configured for the wireless device are used for data transmission to the wireless device, the control signaling resources that are used for data transmission to the wireless device start from logical location after the grant for resources in resources partly used by the grant for resources and last until the end of resources where the grant for resources was found by the wireless device.

64. The method of claim 57:
wherein the grant for resources is transmitted at a logical location; and
wherein, when the control signaling resources configured for the wireless device are used for data transmission to the wireless device, the control signaling resources that are used for data transmission to the wireless device are determined by the logical location of the grant for resources in resources partly used by the grant for resources.

65. The method of claim 64, wherein the control signaling resources that are used for data transmission to the wireless device are determined to start from a logical location after the grant for resources in resources partly used by the grant for resources until the end of all the control signaling resources.

66. The method of claim 57, wherein the first indicator is provided as a bitmap where each bit represents one or more Physical Resource Blocks.

67. The method of claim 66, wherein each bit represents one or more Resource Block Group, each Resource Block Group comprising one or more Physical Resource Blocks.

68. The method of claim 57, wherein the second indicator is provided by at least one indicator bit.

69. The method of claim 57, wherein the grant for resources is provided in a short Transmission Time Interval frequency band.

70. The method of claim 57, wherein the grant for resources is provided in a short Downlink Control Information (sDCI) message.

71. The method of claim 57, wherein the grant for resources is provided on a short Physical Downlink Control Channel (sPDCCH).

72. The method of claim 70:
wherein the grant for resources is provided on a short Physical Downlink Control Channel (sPDCCH); and
wherein the wireless device is configured with at least one sPDCCH set of locations to search for the sDCI.

73. The method of claim 57, wherein the resources are downlink data provided in a short Downlink Shared Channel (sPDSCH) region.

74. The method of claim 70:
wherein the grant for resources is provided on a short Physical Downlink Control Channel (sPDCCH);
wherein the resources are downlink data provided in a short Downlink Shared Channel (sPDSCH) region; and
wherein, when the control signaling resources configured for the wireless device are not used for data transmission to the wireless device, the wireless device is configured to not use any configured sPDCCH resources for sPDSCH.

75. The method of claim 70:
wherein the grant for resources is provided on a short Physical Downlink Control Channel (sPDCCH);
wherein the resources are downlink data provided in a short Downlink Shared Channel (sPDSCH) region; and
wherein, when the control signaling resources configured for the wireless device are used for data transmission to the wireless device, the wireless device is configured to use configured sPDCCH resources after the sDCI message for sPDSCH.

76. A network node for transmitting grant for resources to a wireless device, the network node comprising
processing circuitry;
memory containing instructions executable by the processing circuitry whereby the network node is operative to:
transmit the grant for resources to the wireless device;
wherein the grant comprises a first indicator indicating data resources allocated to the wireless device in a downlink data channel; and
wherein the grant comprises a second indicator indicating whether control signaling resources configured for the wireless device are used for data transmission to the wireless device or are not used for data transmission to the wireless device.

77. A wireless device for receiving granting of resources from a network node, the wireless device comprising:
processing circuitry;
memory containing instructions executable by the processing circuitry whereby the wireless device is operative to:
receive a grant for resources from the network node;
wherein the grant comprises a first indicator indicating data resources allocated to the wireless device in a downlink data channel; and
wherein the grant comprises a second indicator indicating whether control signaling resources configured for the wireless device are used for data transmission to the wireless device or are not used for data transmission to the wireless device.

78. A non-transitory computer readable recording medium storing a computer program product for controlling a network node for transmitting a grant for resources to a wireless device, the computer program product comprising software instructions which, when run on processing circuitry of the network node, causes the network node to:
transmit the grant for resources to the wireless device;
wherein the grant comprises a first indicator indicating data resources allocated to the wireless device in a downlink data channel; and
wherein the grant comprises a second indicator indicating whether control signaling resources configured for the wireless device are used for data transmission to the wireless device or are not used for data transmission to the wireless device.

79. A non-transitory computer readable recording medium storing a computer program product for controlling a wireless device for receiving granting of resources from a network node, the computer program product comprising software instructions which, when run on processing circuitry of the wireless device, causes the wireless device to:
receive a grant for resources from the network node;
wherein the grant comprises a first indicator indicating data resources allocated to the wireless device in a downlink data channel; and
wherein the grant comprises a second indicator indicating whether control signaling resources configured for the wireless device are used for data transmission to the wireless device or are not used for data transmission to the wireless device.
